(19) United States
(12) Patent Application Publication
(10) Pub. No.: US 2022/0012613 A1
(43) Pub. Date: Jan. 13, 2022

(54) SYSTEM AND METHOD FOR EVALUATING MACHINE LEARNING MODEL BEHAVIOR OVER DATA SEGMENTS

(71) Applicant: Truera, Inc., Redwood City, CA (US)

(72) Inventors: Anupam Datta, Redwood City, CA (US); Shayak Sen, Redwood City, CA (US); Apoorv Gupta, Sunnyvale, CA (US); David Sandai Kurokawa, Kirkland, WA (US)

(21) Appl. No.: 17/371,551

(22) Filed: Jul. 9, 2021

Related U.S. Application Data
(60) Provisional application No. 63/049,689, filed on Jul. 9, 2020.

(51) Int. Cl. G06N 5/04; G06N 20/00

(52) U.S. Cl. CPC G06N 5/041; G06N 20/00

(57) ABSTRACT

A computing machine receives a representation of a machine learning model, a representation of a first data segment, and a representation of a second data segment. The computing machine computes an output difference between an output of the machine learning model applied to the first data segment and an output of the machine learning model applied to the second data segment. The computing machine determines a set of reasons for the computed output difference based on a set of metrics defining distance between feature importance distributions, the set of reasons identifying a set of features from a feature vector of the machine learning model along with a relative contribution of each feature to the computed output difference. The computing machine provides an output representing the set of reasons.

### PRIORITY CLAIM

This application claims the benefit of priority under 35 U.S.C. 119(e) to U.S. Provisional Patent Application Ser. No. 63/049,689, filed on Jul. 9, 2020, entitled “SYSTEM AND METHOD FOR EVALUATING MACHINE LEARNING MODEL BEHAVIOR OVER DATA SEGMENTS,” the entire content of which is incorporated herein by reference.

### TECHNICAL FIELD

Embodiments pertain to computer architectures for machine learning. Some embodiments relate to a system and method for evaluating machine learning model behavior over data segments.

### BACKGROUND

In the last decade, machine learning models have become more and more common. These machine learning models are sometimes used to make decisions. For example, in consumer banking, a machine learning model may be used to make a preliminary decision to approve or disapprove a customer for a loan. In some schemes, the machine learning model operates as a black box, providing an output of “approve” or “disapprove,” without any explanation. In some cases, these machine learning models may operate differently on different data segments, potentially in legally-impermissible or legally-questionable ways. For example, male customers may be approved for loans at higher rates than female customers. Identifying when such differences in machine learning model operation occur and/or providing remedies for such differences may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a flow chart of a method for evaluating machine learning model behavior over data segments, in accordance with some embodiments.

FIG. 7 illustrates an example graphical output for evaluating machine learning model behavior over data segments, in accordance with some embodiments.

### SUMMARY

The present disclosure generally relates to machines configured to provide machine learning models, including computerized variants of such special-purpose machines and improvements to such variants. In particular, the present disclosure addresses evaluating machine learning model behavior over data segments.

According to some aspects, a method includes receiving, at a computing machine, a representation of a machine learning model, a representation of a first data segment, and a representation of a second data segment. The method includes computing, at the computing machine, an output difference between an output of the machine learning model applied to the first data segment and an output of the machine learning model applied to the second data segment. The method includes determining, using the computing machine, a set of reasons for the computed output difference based on a set of metrics defining distance between feature importance distributions, the set of reasons identifying a set of features from a feature vector of the machine learning model along with a relative contribution of each feature to the computed output difference. The method includes providing an output representing the set of reasons.

Some aspects include a machine-readable medium storing instructions to perform the above method. Some aspects include a system comprising processing circuitry and memory, the memory storing instructions which, when executed by the processing circuitry, cause the processing circuitry to perform the above method. Some aspects include an apparatus comprising means for performing the above method.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, machine learning models are oftentimes used to make consequential decisions. For example, in consumer banking, a machine learning model may be used to make a preliminary decision to approve or disapprove a customer for a loan. In retail, a machine learning model may be used to identify customers to target with a promotion or advertisement. In spam filtering, a machine learning model may be used to identify an email message as spam or legitimate. The machine learning model may operate as a “black box,” providing an output of “approve” or “disapprove,” without any explanation. In some cases, these machine learning models may operate differently on different data segments, potentially in ways that are impermissible or questionable from a legal or ethical perspective. For example, male customers may be approved for loans at higher rates than female customers. Some aspects of the technology described herein identify when such differences in machine learning model operation occur and/or provide remedies for such differences.

According to some embodiments, a computing machine (or a group of multiple computing machines) receives a representation of a machine learning model, a representation of a first data segment, and a representation of a second data segment. The first data segment and the second data segment may represent any data segments that are to be studied, for example, men/women, residents of California/Texas, messages including/lacking attachments, messages including/lacking spelling errors, and the like. The computing machine computes an output difference between an output of the machine learning model applied to the first data segment and an output of the machine learning model applied to the second data segment. The output difference may include a statistical difference measurement (e.g., an arithmetic difference, a disparate impact ratio, a difference of means, and a Wasserstein distance). The statistical difference measurement may include a difference of model outputs. The model outputs may include log-odds scores, probabilities of classification, class outputs, and/or model errors. The computing machine determines a set of reasons for the computed output difference based on a set of metrics defining distance between feature importance distributions. The set of reasons identifies a set of features from a feature vector of the machine learning model along with a relative contribution of each feature to the computed output difference. The set of metrics may include a metric based on a Difference of Means or a Wasserstein Distance.

According to some embodiments, the computing machine generates a remediation engine for the machine learning model to decrease a magnitude of the output difference, the remediation engine comprising a feature engineering sub-engine that adjusts features from the set of features. The remediation engine selects features for adjustment based on a user input received at the computing machine.

The technology disclosed herein uses various engines, each of which is constructed, programmed, configured, or otherwise adapted, to carry out a function or set of functions. The term “engine” as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

As used herein, the term “computing machine” may include a single computing machine or multiple computing machines. A computing machine may include any device or combination of devices that includes processing circuitry and memory. The processing circuitry and the memory may reside in the same device or in different devices.

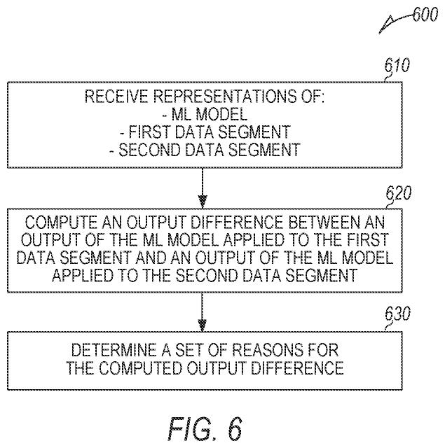

Throughout this document, some method(s) (e.g., in FIG. 6) are described as being implemented serially and in a given order. However, unless explicitly stated otherwise, the operations of the method(s) may be performed in any order. In some cases, two or more operations of the method(s) may be performed in parallel using any known parallel processing techniques. In some cases, some of the operation(s) may be skipped and/or replaced with other operations. Furthermore, skilled persons in the relevant art may recognize other operation(s) that may be performed in conjunction with the operation(s) of the method(s) disclosed herein.

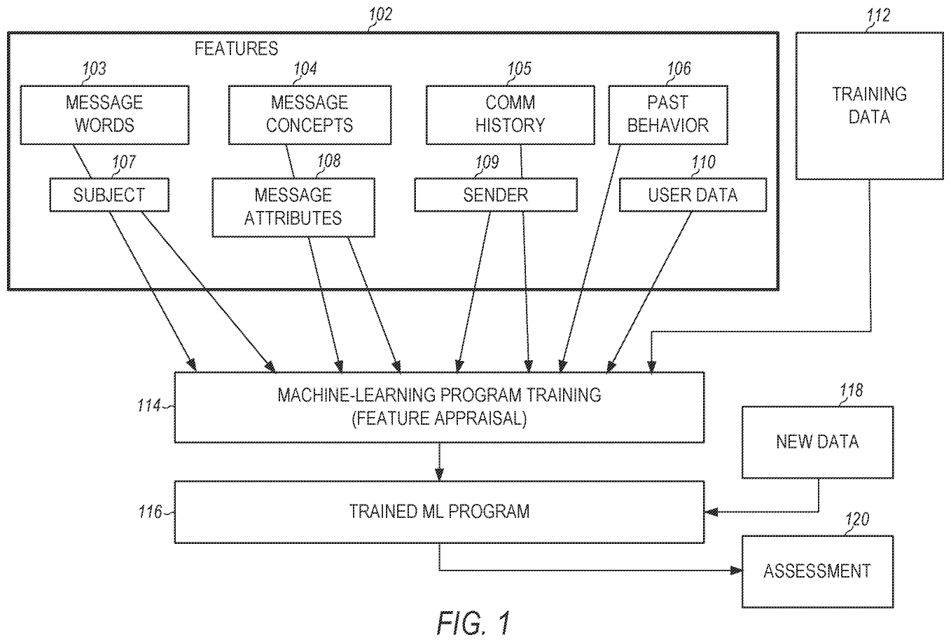

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, the machine-learning program 116 may be asked to count the number of sedans and pickup trucks in a parking lot between 10:00 and 11:00. The machine-learning program 116 determines the required image quality to extract the information that is needed. The machine-learning program 116 determines if a target model exists for sedans and pickup trucks. The machine-learning program 116 locates images having the required image quality to extract the information that is needed. If such images do not exist for the given time and geographic location parameters, the machine-learning program 116 requests collection of such images for the given time and geographic location parameters. Upon receiving the requested or located images, the machine-learning program 116 pushes the images to the appropriate model.

Machine learning techniques train models to accurately make predictions on data fed into the models. During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that is has not been trained on. In a second example, a false positive rate or false negative rate may be used to evaluate the models after finalization. In a third example, a delineation between data clusterings is used to select a model that produces the clearest bounds for its clusters of data.

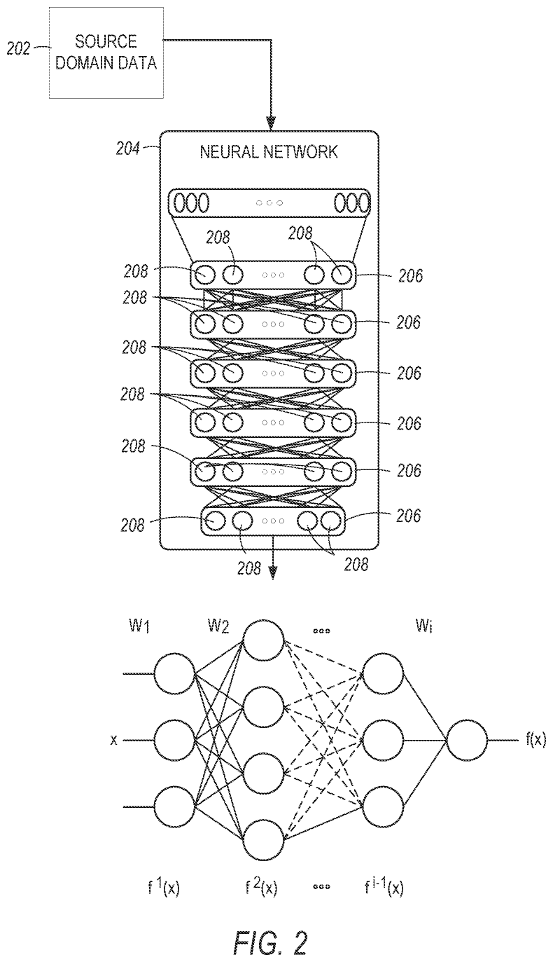

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at fⁱ(x), f²(x), . . . , f⁻¹(x), until finally the output f(x) is computed.

In some example embodiments, the neural network 204 (e.g., deep learning, deep convolutional, or recurrent neural network) comprises a series of neurons 208. A neuron 208 is an architectural element used in data processing and artificial intelligence, particularly machine learning on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized in various configurations of neural networks to provide interactions and relationship learning modeling for how each of the frames in an utterance are related to one another.

For example, a neural network node serving as a neuron includes several gates to handle input vectors (e.g., sections of an image), a memory cell, and an output vector (e.g., contextual representation). The input gate and output gate control the information flowing into and out of the memory cell, respectively. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., patterns in an image). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

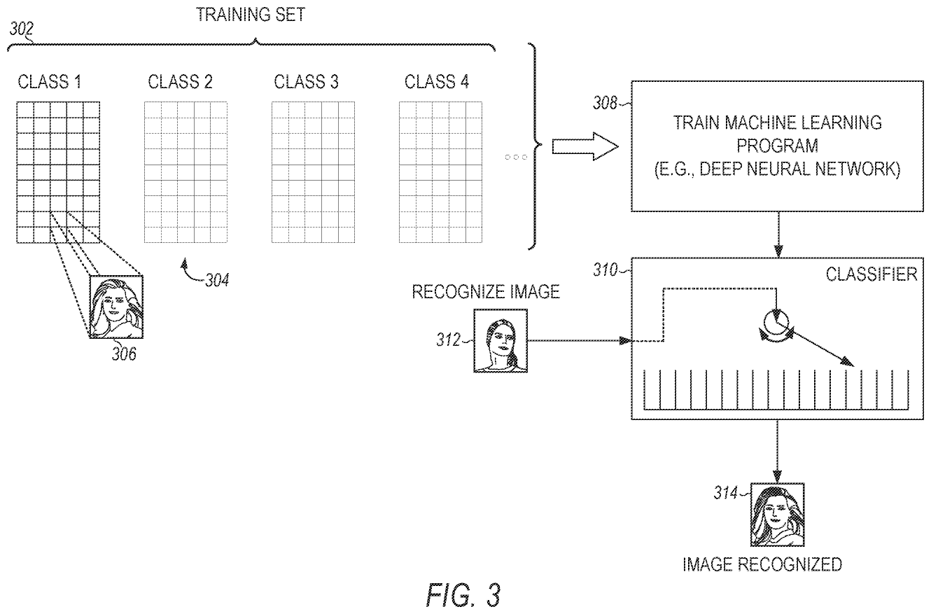

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Barack Obama, one class corresponds to George W. Bush, etc.). At block 308 the machine learning program is trained, for example, using a deep neural network. At block 310, the trained classifier, generated by the training of block 308, recognizes an image 312, and at block 314 the image is recognized. For example, if the image 312 is a photograph of Bill Clinton, the classifier recognizes the image as corresponding to Bill Clinton at block 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

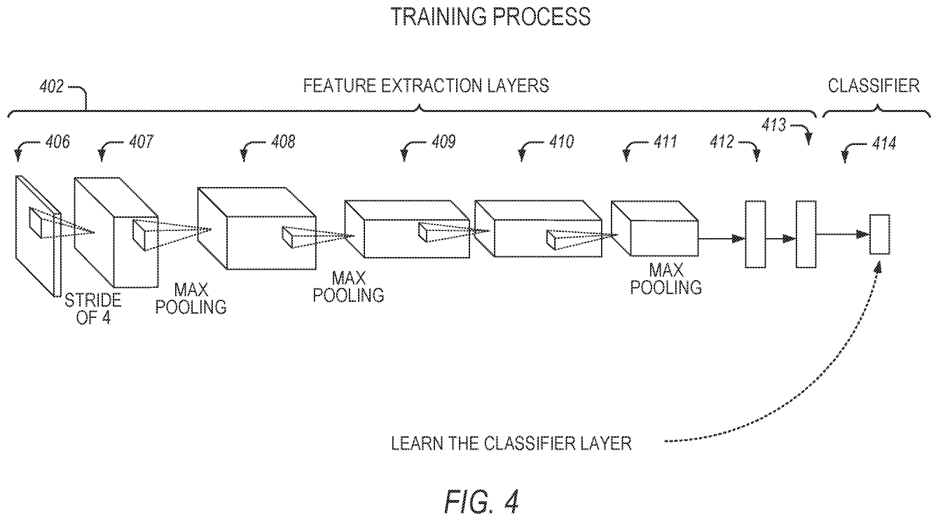

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., using the datasets MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as be reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

FIG. 4 is described in conjunction with a “stride of 4.” However, it should be noted that any other positive integer stride value may be used. Also, FIG. 4 describes some but not all examples of stages of neural network processing. Some aspects of the technology disclosed herein may implement one or more of: convolution, skip connections, activation, batch normalization, dropout, and the predictive function. Skip connections include shortcuts to jump over some layers (e.g., layer m provides input directly to layer m+2). An activation is a minimum amount of input that causes an artificial neuron to “fire” an output. Batch normalization is a technique for training very deep neural networks that standardizes the inputs to a layer for each mini-batch. This has the effect of stabilizing the learning process and dramatically reducing the number of training epochs required to train deep networks. Dropout sets the output of some neurons to zero in order to prevent a neural network from overfitting. The idea of dropout is to randomly drop units (along with their connections) from the artificial neural network during training. This prevents the units from co-adapting too much.

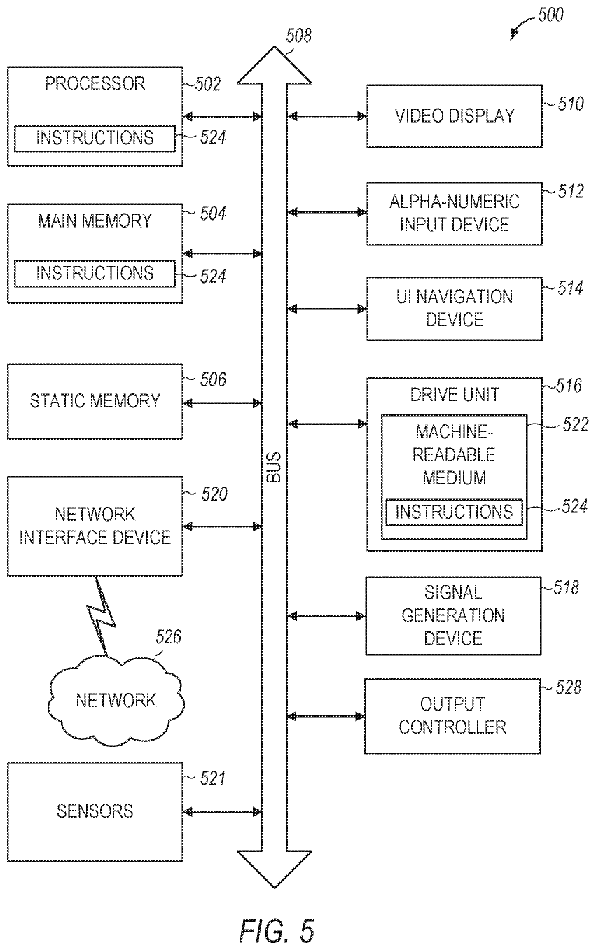

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

FIG. 6 is a flow chart of a method 600 for evaluating machine learning model behavior over data segments, in accordance with some embodiments. The method 600 may be implemented at a computing machine (or, alternatively, at a group of multiple computing machines).

At operation 610, the computing machine receives a representation of a machine learning model, a representation of a first data segment, and a representation of a second data segment.

At operation 620, the computing machine computes an output difference between an output of the machine learning model applied to the first data segment and an output of the machine learning model applied to the second data segment.

The output difference may include a statistical difference measurement. The statistical difference measurement may be one or more of: an arithmetic difference, a disparate impact ratio, a difference of means, and a Wasserstein distance. The statistical difference measurement may include a difference of model outputs. The model outputs may be one or more of: log-odds scores, probabilities of classification, and class outputs.

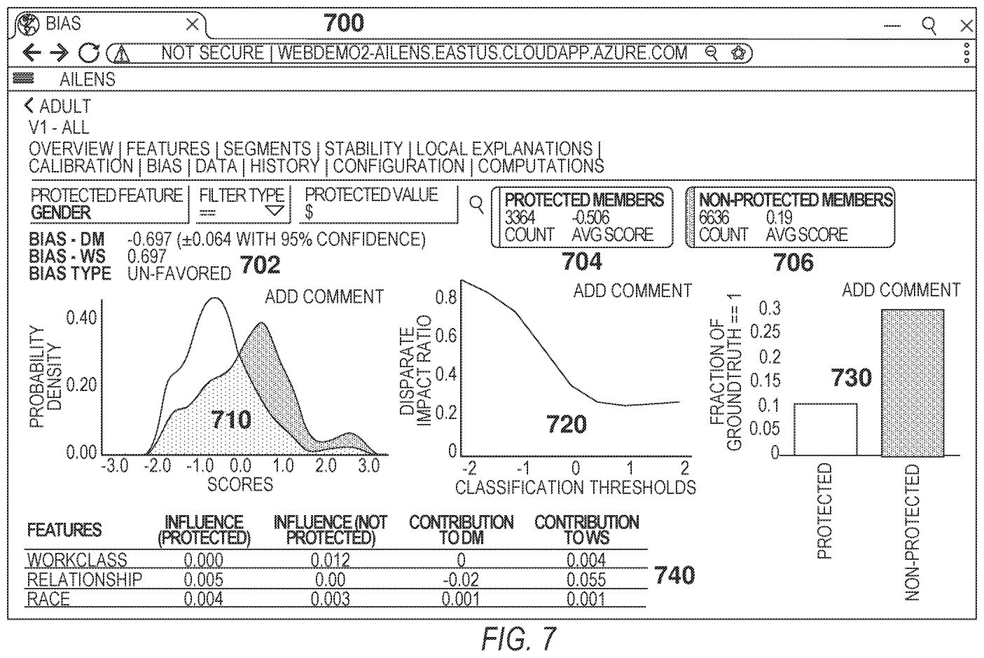

At operation 630, the computing machine determines a set of reasons for the computed output difference based on a set of metrics defining distance between feature importance distributions. The set of metrics may include a metric based on a Difference of Means or a Wasserstein Distance. The set of reasons identifies a set of features from a feature vector of the machine learning model along with a relative contribution of each feature to the computed output difference. The computing machine provides an output representing the set of reasons (e.g., as shown in FIG. 7, which illustrates an example graphical output for evaluating machine learning model behavior over data segments, in accordance with some embodiments).

The computing machine may generate a remediation engine for the machine learning model to decrease a magnitude of the output difference. The remediation engine comprising a feature engineering sub-engine that adjusts features from the set of features. The remediation engine selects features for adjustment based on a user input received at the computing machine.

Some embodiments present a system and method for evaluating how machine learning (ML) models treat two data segments. Some embodiments may involve the following steps.

The input may include a model and two data segments.

Some embodiments apply the model to the two data segments. Some embodiments assess how differently the model treats the two data segments using a set of metrics defining distance between model output distributions. Example metrics include but are not limited to Difference of Means and Wasserstein Distance on different kind of model outputs (e.g. log-odds score, probabilities of classification, class outputs).

Some embodiments determine reasons for differential treatment of input features of the model using a set of metrics defining distance between feature importance distributions. Feature importance can be computed using methods including but not limited to Quantitative Input Influence and Shapley Additive Explanations. Distance between feature importance distributions can be computed using methods like Difference of Means and Wasserstein Distance.

Some embodiments remediate using methods based on understanding which features lead to undesirable model outcomes. Undesirability is determined by input from the user of the system and method. This may be specific to the domain of the model or the way an organization uses the model. Remediation methods include but are not limited to feature engineering to adjust features that are causing problems (e.g., by bucketizing feature values differently, dropping features) such as instability or unwanted differential treatment and retraining the model.

Some embodiments are described below in conjunction with two specific instances for assessing stability and bias in ML models.

In conjunction with assessing stability, a workflow process and methods for performing steps of this process make it possible to assess, determine, and remediate stability problems in machine learning models.

Stability assessment, determination, and remediation are useful during model development and validation because ML models are likely to degrade faster than traditional linear scorecard models if the data distribution changes over time. This fragility arises in part because ML models can learn more complex relationships from the training data than linear scorecard models. These relationships may not be invariant over time.

Stability analysis may involve, among other things comparing the behavior of a model on testing/training data to behavior on live production (also called “out of time” or OOT) data. The workflow process and methods for stability are summarized in Table 1.

TABLE 1
Workflow process and methods for stability.

| | |
|---|---|
| Assessment | Periodically, in model development or use, analysts may use selected signals |
| | to decide whether to determine stability limitations. One signal is to test |
| | whether there is a large gap between the test accuracy of the model and out- |
| | of-time (OOT) accuracy. |
| | If the gap is greater than a threshold, then perform determination |
| | below. |
| | A sample threshold is 15%. |
| Determination | When a signal indicates a stability problem that would be beneficial to |
| | address, the determination step of the process examines different kinds of |
| | test/OOT shifts. A method for determining involves the following steps, using |
| | 15% as a sample threshold: |
| | a. Shift in score distributions (Model Score Stability (MSS)) |
| | if MSS > 15% shift from variance then examine which features |
| | are causing shift via step b. below |
| | b. Shift in feature importance distributions (FIS) |
| | Identify feature importance that have undergone big shifts, i.e. |
| | FIS > 15% from variance |
| | Check if these shifts are in a direction that explains the shift in |
| | the model score distribution. |
| | Dig deeper into why the influence distribution of a feature has |
| | changed, including using step c below. |
| | c. Shift in feature-outcome relationships |
| | Understand how feature-outcome relationships have shifted via |
| | Influence Sensitivity Plots. |
| Remediation | To remedy stability issues identified by determination such as those above, |
| | perform the following actions. |
| | 1. If (more) labelled live production data is available or can be obtained |
| | relatively cheaply, use that in the training phase. |
| | 2. Identify features causing instability via the use of FIS values and |
| | handle them via techniques such as: |
| | a. Dropping them entirely. |
| | b. Using (stronger) regularization hyperparameters on them. |
| | c. Bucketizing them. |
| | d. Normalizing to their own dataset (e.g. to control for inflation). |
| | 3. During training, use regularization techniques such as introducing |
| | regularization terms (e.g. Lasso and Ridge regression), dropout, early |
| | stopping, etc. |
| | 4. If a subset of the training data can be obtained that is similar in |
| | distribution to the live production data, use that for either training or |
| | calibration. |
| Outcomes | Greater model stability |

As used in this document, a consequential data drift has occurred if the distribution of data has changed from train/test to out-of-time (or live production) data in a way that significantly reduces the utility of the model. The determination metrics capture aspects of consequential data drift and identify means to improve stability.

One aspect of consequential data drift is captured by the Model Score Stability (MSS) metric. The higher this metric, the more significant measured drift and hence the stronger the signal that the model may have become unstable and hence require a careful examination. The MSS metric computes the first Wasserstein distance (e.g. the Earth Mover Distance) between the two distributions of model scores—train/test vs out-of-time. The model scores can be measured in log odds, probability, classification outcome or other model outputs. The metric may be interpreted as the average change in model scores in going from train/test to out-of-time data.

The Feature Importance Stability (FIS) metric measures how different the distribution of influences are for a given feature as the computing machine goes from the train/test distribution to the out-of-time distribution of inputs. The higher this metric, the higher is the difference. The FIS metric computes the first Wasserstein distance (e.g. the Earth Mover Distance) between the two distributions of feature importance—train/test vs out-of-time. The metric may be interpreted as the average change in feature importance in going from train/test to out-of-time data.

Determining feature-outcome relationships may be done via Influence Sensitivity Plots. A feature-outcome relationship captures how varying that feature impacts the contribution of the feature to a model's output. An Influence Sensitivity Plot provides a visual representation of this type of relationship. The contribution of the feature to a model's output can be measured using one of several different feature importance computation methods, including but not limited to Quantitative Input Influence and Shapley Additive Explanations.

Some machine learning models may, in some situations, make decisions based on unjust bias. Machine learning models are used in a wide variety of situations, including decisions by customer-facing organizations. For example, a bank may decide whether to approve a loan application using a machine learning model. In such situations, the individuals or organizations using a model may wish to treat various groups of people fairly or equitably. There may also be laws governing the decisions or actions taken by these organizations, including laws prohibiting unjust or unpermitted bias. In this context, a model may exhibit a form of unjust bias if its decisions result in a protected group being treated unfavorably for reasons that are not justifiable. The techniques for identifying unjust bias and subsequent remediation are similar in outline to those for stability and are summarized in Table 2.

TABLE 2
Techniques for identifying unjust bias.

| | |
|---|---|
| Assessment | Bias metrics |
| | Examine how these bias metrics for scoring models translate into |
| | disparate impact ratio based on the decisioning threshold. |
| | If the disparate impact ratio < 0.80 then go to determination below |
| | The determinations may be examined even if the disparate impact ratio |
| | is close to 1 (e.g., greater than a threshold value, such as 0.9 or 0.95) |
| | since unjust bias may arise even in that case if the drivers of the |
| | outcomes are not justifiable. |
| Determination | Identify most important features that are driving the bias |
| | Drill down on most important features driving bias to examine how they |
| | are causing bias using their influence sensitivity plot, influence density |
| | plot, and feature value distribution. |
| Remediation | Drop feature causing bias if its use is not justified and retrain model. |
| | Explore feature engineering to adjust features that are causing bias (e.g., |
| | by bucketizing feature values differently) and retrain the model. |
| | If unjust bias is traced back to data bias (sample selection bias), then |
| | update the data collection process to eliminate data bias. |
| Outcomes | Mitigate bias while maintaining accuracy |

The framework for unjust bias determination may leverage an understanding of the following terms.

Protected group: A protected group identifies a subset of the population.

Unfavorable treatment: A protected group (e.g. women) is treated unfavorably relative to its complement group (e.g. men) if the model's outputs are “significantly worse” for the protected group. The standard for “significantly worse” will vary by jurisdiction. The ratio of favorable decisions for the protected group divided by the favorable decisions for the complement group is known in the United States as the disparate impact ratio.

Reasons for Bias: If a model treats a protected group unfavorably, various features or combinations of features might be found responsible for the bias. Direct use: A protected feature may be directly used by the model (e.g., gender) and cause unfavorable treatment. Indirect or proxy use: Even if the protected feature is not directly used as a feature to the model, it may end up using a “proxy” (an associated feature or feature group) that causes the unfavorable treatment.

Justifiability: It is necessary to assess whether reasons for bias are justifiable. This is typically done by domain experts (data scientists, business, compliance).

FIG. 7 illustrates an example graphical output 700 for evaluating machine learning model behavior over data segments, in accordance with some embodiments.

Group disparity metrics are shown in block 702, block 704, block 706, and graph 710. The two metrics discussed below may be used for measuring group disparity in model outcomes. The higher the value of these metrics the greater is the group disparity. Difference in Means (DM), shown at block 702, is the difference between the means of model scores for the protected group and its complement. For example, the model's mean score for women might be 0.697 less than its mean score for men. If higher scores are better for this model, this metric indicates that the model is treating women unfavorably. Wasserstein Distance (WS), shown at block 702, is the First Wasserstein Distance (e.g. the Earth Mover Distance) between the model score distributions for the two groups.

A group disparity visualization may be provided. Graph 710 is a visualization of the model score distributions for the protected group and its complement. It provides a visual representation of the two distributions and helps arrive at a qualitative understanding of group disparity. In particular, for this example, note that a considerable mass of the distribution for men (right peak of graph 710) is to the right of the distribution of scores for women (left peak of graph 710). This indicates that the model treats men more favorably than women.

Graph 720 illustrates how the disparate impact ratio is impacted by classification thresholds. Graph 730 illustrates the fraction of the ground truth represented by the protected class (e.g. women) and the non-protected class (e.g. men).

Some embodiments allow a ML model's reasons for bias to be discovered. The table at block 740 of FIG. 7 illustrates the features that are driving the bias along with their contributions to the bias metrics, DM and WS. The features can be ordered by their contribution to each metric. In the example of FIG. 7, the feature “relationship” has the highest contribution to both DM and WS—the “relationship” feature accounts for over half of the bias.

Representation can be assessed based on how various features influence model prediction. Typical methods for determining feature influence around a given input point will compute influence as model inputs vary. For example, Quantitative Input Influence (QII), computes feature influence for a sample of data points in the training data set. The general method of computing QII is described as an illustrative example.

Quantitative Input Influence (QII) measures the degree of influence that each input feature exerts on the outputs of the system. There are several variants of QII. Unary QII computes the difference in outputs arising from two related input distributions—the real distribution and a hypothetical (or counterfactual) distribution that is constructed from the real distribution to account for correlations among inputs. Unary QII can be generalized to a form of joint influence of a set of inputs, called Set QII. A third method defines Marginal QII, which measures the difference in output based on comparing training data with and without the specific input whose marginal influence some embodiments want to measure. Depending on the application, some embodiments may choose the training sets the embodiments compare in different ways, leading to several different variants of Marginal QII.

As used herein, a model m and its score output for an input vector \vec{x} is denoted by s=m(\vec{x}).

For an individual feature vector \vec{x}ⁱ, xⁱ_{f} represents the value for feature f. The vector \vec{q}ⁱ represents the vector of feature importance for feature vector \vec{x}ⁱ, as measured by the QII on model m.

An important set of metrics in the document compare two distributions U and V.

Two metrics that may be used, in some examples, are the ‘Difference of Means’ and the ‘Wasserstein Distance.’

The difference of means is simply, as the name describes it, the difference of means of the two distributions. When u and v are represented by a set of observations (U={u₁, . . . , u_{|U|}} and V={v₁, . . . , v_{|V|}}), where |U| is the size of set U and |V| is the size of set V, the difference of means is given by Equation 1.

DM(U,V)=Σ_{x∈U}x/|U|−Σ_{x∈V}x/|V| Equation 1

The difference of means is useful to provide directional information, but only captures a difference in means of distributions, but ignores differences in other parameters such as the variance of the distributions.

The Wasserstein distance measures the minimum amount of distance one needs to move to transform the first distribution into the second. The formal definition of the Wasserstein Distance is given in Equation 2.

WS(u,v)=inf_{Γ(u,v)}∫|x−y|dπ(x,y) Equation 2

In Equation 2, Γ(u, v) is the set of all distributions on x and y. When u and v are represented by a set of observations (U={u₁, . . . , uₘ} and V={v₁, . . . , vₙ}), and let the cumulative density function be represented by cdf_{U}(x)=|{u<x|u∈U}|/|U|, and cdf_{V}(x)=|{v<x|v∈V}|/|V|.

The estimate of the integral of Equation 2 is given by Equation 3.

WS(U,V)=Σ_{x∈U∪V}|cdf_{U}(x)−cdf_{V}(x)|(δx), Equation 3

In Equation 3, δx is the difference between subsequent values of x∈U∪V. The Wasserstein metric has the important property of being able to measure the difference of continuous and discrete distribution while preserving the geometry of the space such that the Wasserstein metric has the same units as the underlying domains being compared. The Wasserstein metric is sensitive to changes in mean, and differences in other attributes of the distribution such as the variance. However, as a result it is not a directional metric.

A model stability score (MSS) may be used in some embodiments. If the output of a model on a set of points from time period T₁ is given by S₁={u₁, . . . , uₘ}, and from time period T₂ is given by S₂={v₁, . . . , vₘ}, then the model score stability is given by WS(S₁, S₂).

Feature importance stability (FIS) may be used in some embodiments. If the feature importance for feature f of a model on a set of points from time period T₁ is given by I₁={u₁, . . . , uₘ}, and from time period T₂ is given by I₂={v₁, . . . , vₘ}, then the model score stability is given by WS(I₁, I₂).

Difference of means may be used in some embodiments. If the output of a model on a set of points from for a protected group G is given by S_{G}={u₁, . . . , uₘ}, and for the remainder of the population P is given by S_{P}={v₁, . . . , vₘ}, then the difference of means bias metric is given by DM(S_{G}, S_{P}).

Wasserstein distance may be used in some embodiments. If the output of a model on a set of points from for a protected group G is given by S_{G}={u₁, . . . , uₘ}, and for the remainder of the population P is given by S_{P}={v₁, . . . , vₘ}, then the wasserstein distance bias metric is given by WS(S_{G}, S_{P}).

Contribution to difference of means may be used in some embodiments. If the influence of a feature f of a model on a set of points from for a protected group G is given by I_{G}={u₁, . . . , uₘ}, and for the remainder of the population P is given by I_{P}={v₁, . . . , vₘ}, then the contribution to the difference of means bias metric is given by DM(I_{G}, I_{P}).

Contribution to Wasserstein distance may be used in some embodiments. If the influence of a feature f of a model on a set of points from for a protected group G is given by I_{G}={u₁, . . . , uₘ}, and for the remainder of the population P is given by I_{P}={v₁, . . . , vₘ}, then the contribution to the Wasserstein distance bias metric is given by WS(I_{G}, I_{P}).

Feature importance can be computed using methods including but not limited to Quantitative Input Influence and Shapley Additive Explanations. Below is provided a brief overview of one technique for computing feature importance called Quantitative Input Influence.

The input is a model M with a vector of features <f1, f2, . . . , fn>, a dataset D of individuals along with their feature values, and a query Q.

The output is feature importance scores for each of the features <f1, f2, f3, . . . , fn> that explain the query Q for the model M.

A query Q captures a property of the model M's behavior. Examples of queries include the following. Why does the model M give a credit risk score of 665 to Jane? Why did the model M deny John credit? Why does the model approve women at 70% of the rate that it approves men?

A feature importance score vector identifies how much each of the n features contributes to model's behavior on which the query focuses.

The feature importance computation for a query involving a single prediction (e.g., why was Jane denied credit) may involve the following steps.

First, a computing machine creates a set of near clones of the input point by intervening on subsets of the features. One way to create the near clones is to start from the input point and intervene on a subset of features by sampling from their joint marginal distribution in the data set D.

Second, the computing machine computes the model's prediction on the near clones.

Third, the computing machine summarizes the importance of the different features using a co-operative game-theoretic index (e.g. the Shapley Value) that computes the average marginal contribution of the feature to all possible subsets of features.

Some embodiments are described below as numbered examples (Example 1, 2, 3 . . . ). These examples are provided as examples only and do not limit the disclosed technology.

Example 1 is a method comprising: receiving, at a computing machine, a representation of a machine learning model, a representation of a first data segment, and a representation of a second data segment; computing, at the computing machine, an output difference between an output of the machine learning model applied to the first data segment and an output of the machine learning model applied to the second data segment; determining, using the computing machine, a set of reasons for the computed output difference based on a set of metrics defining distance between feature importance distributions, the set of reasons identifying a set of features from a feature vector of the machine learning model along with a relative contribution of each feature to the computed output difference; and providing an output representing the set of reasons.

In Example 2, the subject matter of Example 1 includes, generating, using the computing machine, a remediation engine for the machine learning model to decrease a magnitude of the output difference, the remediation engine comprising a feature engineering sub-engine that adjusts features from the set of features.

In Example 3, the subject matter of Example 2 includes, wherein the remediation engine selects features for adjustment based on a user input received at the computing machine.

In Example 4, the subject matter of Examples 1-3 includes, wherein the set of metrics comprises a metric based on a Difference of Means or a Wasserstein Distance.

In Example 5, the subject matter of Examples 1-4 includes, wherein the output difference comprises a statistical difference measurement.

In Example 6, the subject matter of Example 5 includes, wherein the statistical difference measurement is one or more of; an arithmetic difference, a disparate impact ratio, a difference of means, and a Wasserstein distance.

In Example 7, the subject matter of Examples 5-6 includes, wherein the statistical difference measurement comprises a difference of model outputs, the model outputs being one or more of: log-odds scores, probabilities of classification, and class outputs.

Example 8 is at least one machine-readable medium including instructions that, when executed by processing circuitry, cause the processing circuitry to perform operations to implement of any of Examples 1-7.

Example 9 is an apparatus comprising means to implement of any of Examples 1-7.

Example 10 is a system to implement of any of Examples 1-7.

Example 11 is a method to implement of any of Examples 1-7.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving, at a computing machine, a representation of a machine learning model, a representation of a first data segment, and a representation of a second data segment;
computing, at the computing machine, an output difference between an output of the machine learning model applied to the first data segment and an output of the machine learning model applied to the second data segment;
determining, using the computing machine, a set of reasons for the computed output difference based on a set of metrics defining distance between feature importance distributions, the set of reasons identifying a set of features from a feature vector of the machine learning model along with a relative contribution of each feature to the computed output difference; and
providing an output representing the set of reasons.

2. The method of claim 1, further comprising:
generating, using the computing machine, a remediation engine for the machine learning model to decrease a magnitude of the output difference, the remediation engine comprising a feature engineering sub-engine that adjusts features from the set of features.

3. The method of claim 2, wherein the remediation engine selects features for adjustment based on a user input received at the computing machine.

4. The method of claim 1, wherein the set of metrics comprises a metric based on a Difference of Means or a Wasserstein Distance.

5. The method of claim 1, wherein the output difference comprises a statistical difference measurement.

6. The method of claim 5, wherein the statistical difference measurement is one or more of: an arithmetic difference, a disparate impact ratio, a difference of means, and a Wasserstein distance.

7. The method of claim 5, wherein the statistical difference measurement comprises a difference of model outputs, the model outputs being one or more of: log-odds scores, probabilities of classification, and class outputs.

8. A non-transitory machine-readable medium storing instructions which, when executed by processing circuitry, cause the processing circuitry to:
receive a representation of a machine learning model, a representation of a first data segment, and a representation of a second data segment;
compute an output difference between an output of the machine learning model applied to the first data segment and an output of the machine learning model applied to the second data segment;
determine a set of reasons for the computed output difference based on a set of metrics defining distance between feature importance distributions, the set of reasons identifying a set of features from a feature vector of the machine learning model along with a relative contribution of each feature to the computed output difference; and
provide an output representing the set of reasons.

9. The machine-readable medium of claim 8, wherein the instructions, when executed by the processing circuitry, further cause the processing circuitry to:
generate a remediation engine for the machine learning model to decrease a magnitude of the output difference, the remediation engine comprising a feature engineering sub-engine that adjusts features from the set of features.

10. The machine-readable medium of claim 9, wherein the remediation engine selects features for adjustment based on a user input received at the processing circuitry.

11. The machine-readable medium of claim 8, wherein the set of metrics comprises a metric based on a Difference of Means or a Wasserstein Distance.

12. The machine-readable medium of claim 8, wherein the output difference comprises a statistical difference measurement.

13. The machine-readable medium of claim 12, wherein the statistical difference measurement is one or more of: an arithmetic difference, a disparate impact ratio, a difference of means, and a Wasserstein distance.

14. The machine-readable medium of claim 12, wherein the statistical difference measurement comprises a difference of model outputs, the model outputs being one or more of: log-odds scores, probabilities of classification, and class outputs.

15. A system comprising:
processing circuitry; and
a memory storing instructions which, when executed by the processing circuitry, cause the processing circuitry to:
receive a representation of a machine learning model, a representation of a first data segment, and a representation of a second data segment;
compute an output difference between an output of the machine learning model applied to the first data segment and an output of the machine learning model applied to the second data segment;
determine a set of reasons for the computed output difference based on a set of metrics defining distance between feature importance distributions, the set of reasons identifying a set of features from a feature vector of the machine learning model along with a relative contribution of each feature to the computed output difference; and
provide an output representing the set of reasons.

16. The system of claim 15, wherein the instructions, when executed by the processing circuitry, further cause the processing circuitry to:
generate a remediation engine for the machine learning model to decrease a magnitude of the output difference, the remediation engine comprising a feature engineering sub-engine that adjusts features from the set of features.

17. The system of claim 16, wherein the remediation engine selects features for adjustment based on a user input received at the processing circuitry.

18. The system of claim 15, wherein the set of metrics comprises a metric based on a Difference of Means or a Wasserstein Distance.

19. The machine-readable medium of claim 15, wherein the output difference comprises a statistical difference measurement.

20. The machine-readable medium of claim 19, wherein the statistical difference measurement is one or more of: an arithmetic difference, a disparate impact ratio, a difference of means, and a Wasserstein distance.
